(19) United States
(12) Patent Application Publication
(10) Pub. No.: US 2008/0125148 A1
(43) Pub. Date: May 29, 2008

(54) CONVEYING RELATION INFORMATION USING ELECTRONIC BUSINESS CARDS

(75) Inventors: HONGJUN ZHAO, NANJING (CN); VON A. MOCK, BOYNTON BEACH, FL (US); XIANG SHEN, NANJING (CN); TIAN-GANG XIE, NANJING (CN)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/673,694

(22) Filed: Feb. 12, 2007

Related U.S. Application Data
(60) Provisional application No. 60/867,291, filed on Nov. 27, 2006.

(51) Int. Cl. H04Q 7/20; G06F 19/00

(52) U.S. Cl. 455/466; 235/375

(57) ABSTRACT

One aspect of the present invention can include a method for exchanging relation information between mobile devices. The method can include a step of identifying a first mobile device associated with a first user that includes a first contact list and identifying a second mobile device including a second contact list. The first mobile device can electronically convey contact information for at least one contact in the first contact list to the second mobile device. The contact can be a person other than the first user. The contact information can include a relation between the first user and the contact. The second mobile device can add the conveyed contact information to the second contact list. After the adding step, the relation between the first user and the contact can be specified within the second contact list.

### CROSS-REFERENCE TO RELATED APPLICATIONS

The present application claims the benefit of U.S. Provisional Application No. 60/867,291 filed 27 Nov. 2006, which is hereby incorporated by reference herein.

### BACKGROUND

1. Field of the Invention

The present invention relates to electronic business cards and, more particularly, to conveying relation information using electronic business cards.

2. Description of the Related Art

Electronic business cards are the digital analog of printed business cards, which have numerous advantages over their printed counterparts. From a recipient's perspective, electronic business cards are generally easy to integrate into popular contact management applications, which saves time, expense, and mistakes of scanning or transcribing printed business cards. From an originator's viewpoint, electronic business cards are cheaper, easier to carry, and convey more comprehensive information then printed cards. Exchange of electronic business cards can occur between proximate mobile computing devices over a personal area network (PAN), such as a BLUETOOTH connection or can occur over a wide area network (WAN) in a variety of manners. For example, electronic business cards can be conveyed as email attachments, as part of a software assisted telephony interaction, between teleconferencing participants using a software interface, and in a variety of other manners, such as over a push-to-talk (PTT) mobile telephony channel.

One evolving practice is for two communicators to exchange third party contact information using electronic business cards. For example, a first communicating party can select a contact from a contact list and convert it into an electronic business card, which is conveyed to a second communicating party, who can automatically import this information into his/her own contact list. This has compatibility advantages because a majority of contact management applications support standardized electronic business card formats, such as the vCard format, even though many popular contact management applications are otherwise incompatible with one another.

No known system or solution permits communicators to specify relationship information within electronic business cards, where the relationship data defines the relationship between a card sender and the person or entity that the electronic business card defines. For example, no known solution permits a sender to convey to a recipient that he/she is the father, friend, boss, or whatnot for the person specified in the electronic business card.

### SUMMARY OF THE INVENTION

A solution for conveying relationship information within electronic business cards. The relationship information can specify a relationship between a card sender and the contact specified within the card. A recipient receiving this information can automatically add it to his/her contact management data store. The relationship information can be used in a variety of fashions. For example, a user can select a contact in a contact management list and filter the list to show only those contacts that are family members or friends of the selected contact.

The present invention can be implemented in accordance with numerous aspects consistent with the material presented herein. For example, one aspect of the present invention can include a method of exchanging contact information. In the method a first person can send an electronic business card specifying contact information for a third person to a second person. The electronic business card can include relation information specifying a relation between the first person and the third person.

Another aspect of the present invention can include a method for exchanging relation information between mobile devices. The method can include a step of identifying a first mobile device associated with a first user that includes a first contact list and identifying a second mobile device including a second contact list. The first mobile device can electronically convey contact information for at least one contact in the first contact list to the second mobile device. The contact can be a person other than the first user. The contact information can include a relation between the first user and the contact. The second mobile device can add the conveyed contact information to the second contact list. After the adding step, the relation between the first user and the contact can be specified within the second contact list.

Still another aspect of the present invention can include an electronic business card configured to be electronically conveyed between a sender and a receiver. The business card can include an identifier for the sender and contact information of a third person, who is a person other than the sender and the receiver. The card can further include a relation type identifier that identifies a type of relation existing between the sender and the third person. The card can also include at least one relation attribute. The relation attribute can include a relation name, an attribute specifying whether the relation is unidirectional or bidirectional, and/or and attribute for a trust level that is based upon a strength of contacts between the sender and the third person.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a flow chart of a method for conveying relation information when exchanging contact information between two computing devices.

FIG. 2 is a schematic diagram of a system for conveying relation information when exchanging contact information between two computing devices.

### DETAILED DESCRIPTION OF THE INVENTION

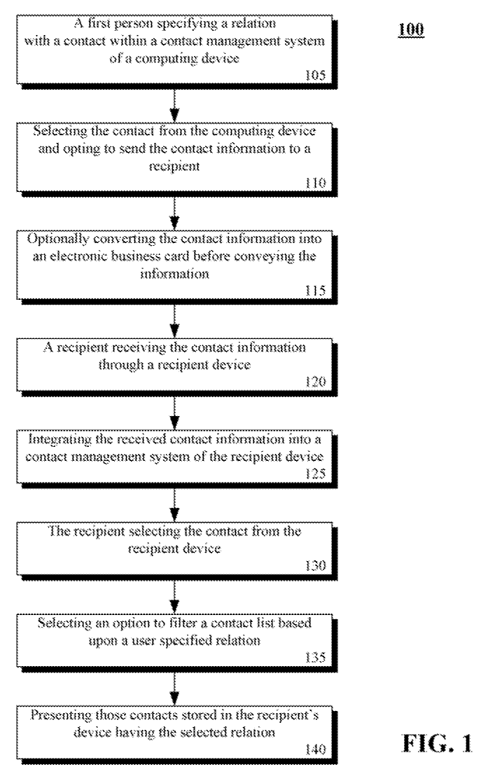

FIG. 1 is a flow chart of a method 100 for conveying relation information when exchanging contact information between two computing devices. Method 100 can begin in step 105, where a person can specify a relation with a contact that is stored in a contact management system of their computing device. For example, the computing device can be a mobile phone in which a user specifies that a person in a contact list (e.g., phonebook) is the user's wife. The user can then meet with a friend, who requests the contact information for the user's wife.

In step 110, the user can select any entry for his wife and select an option to send this contact to the friend. For example, an option of the mobile phone can permit contact sharing with the friend's computing device. One contemplated contact sharing mechanism is using electronic business cards to share information, as shown in step 115. Other information sharing formats can be utilized, however, and the invention is not to be limited in this regard. Further, the contact sharing technique can occur by attaching an electronic business card to email, by conveying the card over a BLUETOOTH connection, by using Push-to-Experience functionality of a mobile telephony device (i.e., an extension to a Push-to-Talk over cellular technology), and by any other technique.

In step 120, a recipient can receive the contact information through a recipient device. In step 125, the received contact information can be integrated into a contact management system of the recipient device. For example, when the contact information is conveyed via an electronic business card, the card can be imported into the contact management system. In step 130, the recipient can select a contact from within an interface of their device. The selected contact can be either the user who sent the contact information or his wife. In step 135, an option to filter a contact list or perform some other programmatic action pertaining to a contact can be selected. The programmatic action can utilize the stored relation information. For example, all contact stored in the computing device having a specified relation can be displayed, as shown in step 140. That is, if the original user was selected along with an option to view his family members, all contacts having this relationship will be presented, which includes the wife.

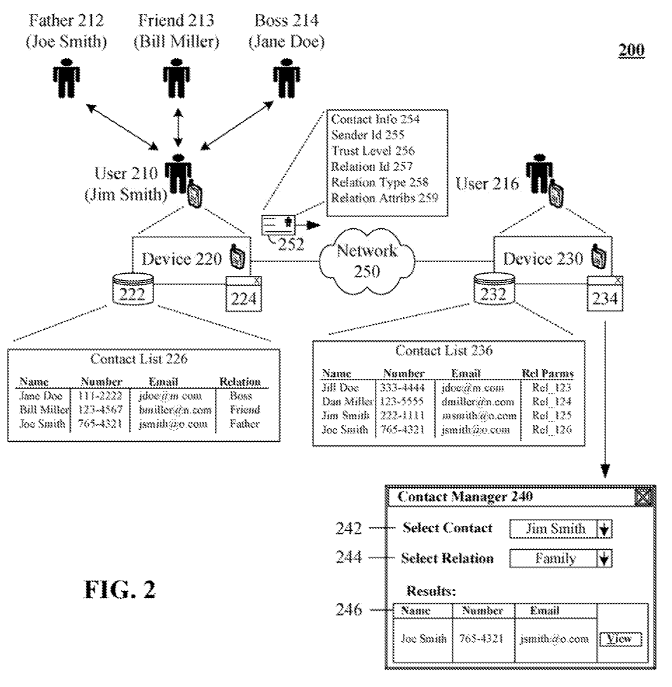

FIG. 2 is a schematic diagram of a system 200 for conveying relation information when exchanging contact information between two computing devices 220 and 230. In one configuration, method 100 can be performed in the context of system 200.

System 200 can include a user 210 (e.g., John Smith) who is associated with computing device 220. Device 220 can include a contact management application 224, which uses contact stored in a contact list 226 contained in data store 222. Each contact in the list can include a name, a phone number, an email address, and other contact information. Each contact can also include a relation that the contact has with the user 210. For example, the contact list 226 can specify that Joe Smith is the father 212 of user 210. Bill Miller can be specified as a friend 213. Jane Doe can be specified as a boss 214.

User 210 can choose to share information from contact list 226 with another user 216. An electronic business card 252 can be generated from information of data store 222 and sent to device 230 over network 250. The electronic business card 252 can include contact information 254, a sender id 255, a trust level 256, a relation id 257, a relation type 258, additional relation attributes 259, and/or other such information.

The contact information 254 can include standard information used by a contact management application 222, such as name, address, phone number, email address, picture, and the like. The sender id 255 can be a unique identifier for user 210, which can be a private or hidden identifier. The relation identifier 257 can be a unique identifier for a particular relation.

The relation type 258 an be an identifier for a particular type of relation. The same identifiers can be used by all users 210 and 216 that share relation information to ensure standardized handling. Different levels of granularity can exist for different relation types 258, where lower level relation types 258 can have a hierarchically established relationship with higher level types. For example, lower level relations of mother, father, brother, sister, aunt, uncle, etc. can be related to a higher level relation type of family. In another example, boss, subordinate, and peer can all be related to a higher level relation type 258 of business colleague. In still another example, sports teammate, girlfriend/boyfriend, computer gaming acquaintance, and the like can all be related to a higher level relation type 258 of friend.

One special relation type 258 can be a user defined type, which can have the same identifier regardless of the defined type. One or more additional relation attributes 259, such as relation type name, can be used to distinguish different user defined relation types 258.

Any number of relation attributes 259 can be defined for a relation. One notable attribute 259 includes an attribute that indicates whether a relation type is directional or not. An example of a non-directional relation is a friend and an example of a directional relationship is father. A directional relation may have to be translated to a different relation when taken from an opposing direction, which can be done automatically. For example, a relation from a first person to a second person can be that of father. The relation of the second person to the first person can be that of a son.

Relationships can be expressed in any number of fashions. To illustrate, consider the father relationship, which can be shown symbolically as R1(A,B). Here, R1 an be a relation type 258 of father, A can be an identifier (e.g., sender id 255) for a first person, and B can be a unique identifier for a second person (e.g., an identifier for the contact specified in contact info 254).

It should be appreciated that a contact in contact list 226 and/or contact list 236 can participate in multiple relations. In one embodiment, a data base structure can be used to maintain appropriate relationships between people. For example, a relation database of a relational database management system (RDBMS) in third normal form (3NF) can include a Relation-Type-Table with attributes of relation type 258 (i.e., primary key), relation type name, and relation direction. The RDBMS can also include a Relation-Table, which includes attributes of a relation id 257 (i.e., primary key of the Relation-Table), a first person id (i.e., foreign key to a record in a person table), a second person id (i.e., foreign key to a record in a person table), and a relation type 258 (i.e., foreign key to the Relation-Type-Table).

Trust level 256 can represent how trustworthy the user 210 is regarding information contained within card 252. The trust level 256 can be determined based upon how close within a social network user 210 is to a contact of card 252. A value for trust level 256 can be automatically determined using information such as how often user 210 communicates to the contact, how often user 210 is in close proximity to the contact, and other such information. A number of times and duration of contact can be automatically obtained from device 220, assuming the device 220 is a communication device through which communications are conducted. Similarly, proximity to the contact can be determined from device 220 obtained information, such as how often the contact and the user 210 were within BLUETOOTH range of each other. A time of day, day of week, and duration of proximity can also be factors for determining the trust level 256.

Once device 230 receives card 252, the information contained within can be extracted and placed within data store 232, which can include a contact list 236 associated with a contact management application 234 of device 230. The relation information contained within card 252 can be extracted as well and can be properly associated with user 210. For example, user 210 can send contact information for Joe Smith (father 212) over network 250, causing a new entry for Joe Smith to be added to contact list 236.

After the card 252 has been received and processed by device 230, the contact and relation information can be utilized. For example, user 216 can be presented with interface 240. In interface 240, a contact 242 of Jim Smith (user 210) can be selected along with a relation 244 of type family. This causes each contact in contact list 236 to be searched for family members of Jim Smith. As shown in result table 246, one entry can be found, which is an entry for Joe Smith (father 212), whose contact information was previously conveyed within card 252.

It should be appreciated that the ability to exchange relation data between devices 220 and 230 via card 252 can be applied in a myriad of social networking contexts. In many of these contexts, exchanges of contacts via one or more card 252 can occur automatically. In such a case either user 210 and 216 can establish configurable rules related to the automated sharing of contact information. For example, user 210 can elect to automatically share contact information while user 216 can elect to not automatically share contact information. In another example, user 210 can elect to share contact information only when a recipient includes a contact in their contact list who is within two (or any other configurable number) social networking hops of the shared contact.

In still another example, user 216 can choose to restrict the automatic sharing of contacts having a family relation to user 216 to only those individuals who also have a family relation with user 216. Further restrictions can be placed upon particular individuals (i.e., do not share with Bill Miller) and upon particular contacts (i.e., contact information for Jill Doe is private and is not to be shared with anyone).

As used herein, electronic business card 252 can be an electronic file that contains personal data interchange information. The electronic business card 252 can conform to a known standard, such as a vCard compliant standard, an hCard microformat standard, an iCard compliant standard, and the like.

Each of the devices 220 and 230 can be any computing device capable of sharing contact information. Devices 220 and 230 can include mobile telephones, computers, personal data assistants (PDA's), two-way radios, media players, entertainment systems, wearable computing devices, and the like. Different communication modes can be available to the devices 220 and 230, which can permit information to be shared over a direct communication channel (e.g., USB connection or infrared connection), a personal area network (PAN), and/or a Wide Area Network (WAN).

Network 250 can include any hardware/software/and firmware necessary to convey digital content encoded within carrier waves. Digital content can be contained within analog or digital signals and conveyed though data or voice channels. Network 250 can include network equipment, such as routers, data lines, hubs, and intermediary servers which together form a data or telephony network. Network 250 can include mobile communication components, such as cellular communication towers, two-way radio transceiving components, and the like.

Data stores 222 and 232 can each be a physical or virtual storage space configured to store digital information. Each of data stores 222 and 232 can be physically implemented within any type of hardware including, but not limited to, a magnetic disk, an optical disk, a semiconductor memory, a digitally encoded plastic memory, a holographic memory, or any other recording medium. The data stores 222 and 232 can be a stand-along storage unit as well as a storage unit formed from a plurality of physical devices. Additionally, information can be stored within data store 222 and 232 in a variety of manners. For example, information can be stored within a database structure or can be stored within one or more files of a file storage system, where each file may or may not be indexed for information searching purposes. Further, data stores 222 and 232 can utilize one or more encryption mechanisms to protect stored information from unauthorized access.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of exchanging contact information comprising:
a first person sending an electronic business card specifying contact information for a third person to a second person, wherein said electronic business card includes relation information specifying relation between the first person and the third person.

2. The method of claim 1, further comprising:
conveying the electronic business card from a first mobile device associated with the first person to a second mobile device associated with the second person.

3. The method of claim 2, wherein the first mobile device includes a first phone book and wherein the second mobile device includes a second phone book, said method further comprising:
the first mobile device automatically creating the electronic business card from an entry in the first phone book; and
the second mobile device automatically creating a new entry in the second phone book for the third person, said new entry being created from information included within the electronic business card, and wherein said new entry includes the relation information.

4. The method of claim 2, wherein said first mobile device and said second mobile device are mobile telephony devices having a two way radio capability, said conveying step further comprising:
utilizing the two-way radio capabilities of the first mobile device and the second mobile device to convey the electronic business card.

5. The method of claim 1, further comprising:
conveying the electronic business card from a first computing device associated with the first person to a second computing device associated with the second person, said first computing device having a memory containing a first contact list;
the first computing device receiving a user selection of an entry of the first contact list associated with the third person; and
the first computing device automatically generating the electronic business card from information of the entry.

6. The method of claim 5, wherein the second computing device has a memory containing a second contact list, said method further comprising:
the second computing device importing information in the electronic business card to the second contact list to automatically create a new entry for the third person in the second contact list.

7. The method of claim 1, wherein a computing device of the second person receives the electronic business card, said method further comprising:
automatically importing the information contained in the electronic business card into a memory of the computing device containing a contact list; and
the computing device performing at least one programmatic action based upon a selection of an entry in the contact list, said entry corresponding to at least one of the first person and the third person, said programmatic action utilizing the relation information imported from the electronic business card.

8. The method of claim 1, wherein a computing device of the second person receives the electronic business card, said method further comprising:
automatically importing the information contained in the electronic business card into an indexed data storage space of the computing device; and
the computing device performing at least one programmatic action relating to social networking, said programmatic action relating to the third person and being based upon the imported information.

9. The method of claim 1, wherein the electronic business card includes an identifier for the first person, contact information of the third person, a relation type identifier, and at least one relation attribute.

10. The method of claim 9, wherein the at least one relation attribute comprises a trust level based upon a strength of contact between the first person and the third person.

11. The method of claim 9, wherein the relation is unidirectional.

12. The method of claim 9, wherein the relation is bidirectional.

13. The method of claim 9, wherein the relation is a user defined type defined by the first person.

14. The method of claim 1, wherein the electronic business card conforms to at least one of a vCard based format and an iCard based format.

15. The method of claim 1, further comprising:
defining a plurality of standard relation types; and
presenting the standard relation types within an interface of a computing device associated with the first person for user selection, wherein the relation information included in the electronic business card is one of the relation types selected by the first person.

16. The method of claim 1, wherein said steps of claim 1 are steps performed by at least one machine in accordance with at least one computer program stored within a machine readable memory, said computer program having a plurality of code sections that are executable by the at least one machine.

17. A method for exchanging relation information between mobile devices comprising:
identifying a first mobile device associated with a first user that includes a first contact list and identifying a second mobile device including a second contact list;
the first mobile device electronically conveying contact information for at least one contact in the first contact list to the second mobile device, wherein the contact is a person other than the first user, the contact information including a relation between the first user and the contact;
the second mobile device adding the conveyed contact information to the second contact list, wherein after the adding step, the relation between the first user and the contact that was included in the contact information is specified within the second contact list.

18. The method of claim 17, wherein the contact information is conveyed between the first mobile device and the second mobile device within an electronic business card.

19. An electronic business card configured to be electronically conveyed between a sender and a receiver comprising:
an identifier for the sender;
contact information of a third person, who is a person other than the sender and the receiver;
a relation type identifier that identifies a relation between the sender and the third person; and
at least one relation attribute, said at least one relation attribute including at least one attribute selected from a group of attributes consisting of a relation name, an attribute specifying whether the relation is unidirectional or bidirectional, and an attribute for a trust level that is based upon a strength of contacts between the sender and the third person.

20. The method of claim 19, wherein the electronic business card is automatically generated from a contact list entry stored within a memory of a computing device of the sender, and wherein the electronic business card is used to automatically create a new entry within a contact list stored in a memory of a second computing device of the receiver, said new entry including the relation between the sender and the third person.
